(19) United States
(12) Patent Application Publication
(10) Pub. No.: US 2024/0046371 A1
(43) Pub. Date: Feb. 8, 2024

(54) Computer Systems and Methods for Determining Recommended Cost Codes for Time Entries

(71) Applicant: Procore Technologies, Inc., Carpinteria, CA (US)

(72) Inventors: Chris Karcher, Santa Barbara, CA (US); Arsh Kaur, Oxnard, CA (US); Marc Duncan, Ventura, CA (US); Taylor Wasser, Toronto (CA)

(21) Appl. No.: 17/879,709

(22) Filed: Aug. 2, 2022

(51) Int. Cl. G06Q 40/00; G06Q 50/08

(52) U.S. Cl. CPC G06Q 40/125; G06Q 50/08

(57) ABSTRACT

A computing system is configured to receive, from a client device, a first communication comprising an initial set of user-defined information for a new time entry related to a construction project, wherein the initial set of user-defined information includes (i) a date and (ii) identifying information for at least one individual working on the construction project; obtain contextual information related to the at least one individual's work; based at least on the initial set of user-defined information and the contextual information, identify a set of one or more recommended cost codes for the new time entry; cause the client device to display the set of one or more recommended cost codes; receive, from the client device, a second communication that includes a given cost code that has been selected from the one or more recommended cost codes; and create the new time entry comprising the given cost code.

### BACKGROUND

Construction projects are often complex endeavors involving the coordination of many professionals across several discrete phases. Typically, a construction project commences with a design phase, where architects design the overall shape and layout of a construction project, such as a building. Next, engineers engage in a planning phase where they take the architects' designs and produce engineering drawings and plans for the construction of the project. At this time, engineers may also design various portions of the project's infrastructure, such as HVAC, plumbing, electrical, etc., and produce plans reflecting these designs as well. After, or perhaps in conjunction with, the planning phase, contractors may engage in a logistics phase to review these plans and begin to allocate various resources to the project, including determining what materials to purchase, scheduling delivery, and developing a plan for carrying out the actual construction of the project. Finally, during the construction phase, construction professionals begin to construct the project based on the finalized plans.

### OVERVIEW

Managing and tracking the progress of a construction project can be an arduous task. For instance, work for the construction project must be meticulously tracked—not only in the form of information for time spent working on the construction project, but also in the form of information about specific tasks on which time was spent—so that schedule progress for the construction project can be tracked accurately, the budget for the construction project can be managed and distributed appropriately, and payroll can be approved and processed in a timely manner. Construction professionals are typically required to log every instance of time spent on each task performed for the construction project and then submit that time to be approved for billing and payment, which can be time-consuming, cumbersome, and prone to user error. In instances where one construction professional (e.g., a project manager, a crew foreman, etc.) is responsible for managing a group of other construction professionals, tracking detailed information about work activity, time, labor, and resources, for the entire group in a consistent way can be particularly challenging.

In an effort to alleviate some of the challenges associated with tracking and billing time and labor spent on work for a construction project, software technology has been developed to digitize timekeeping for construction projects. For instance, Procore Technologies, Inc. (“Procore”), who is the assignee of the present application, offers a construction management software application that includes various software tools that facilitate management of different aspects of tracking time for work performed in relation to a construction project. For example, such software tools may enable construction professionals to create and manage time entries for work performed on a construction project. Further, such software tools may enable a construction professional to enter other information for a time entry that may facilitate billing and/or payroll processes, such as information about a given task for which work was performed, or information about whether a given time entry is billable against a project budget, as some examples.

While this existing software technology for tracking time spent working on a construction project provides benefits to construction professionals involved in creating, managing, and processing time entries for work performed on a construction project, it still presents some shortcomings.

As one example, the existing software technology for managing time entries for work performed on a construction project typically requires each new time entry that is created to include information about the type of work performed for that entry, which can be useful for managing, accounting, and billing of time, labor, and resources spent on work for the construction project. However, the existing software technology fails to address the burden on construction professionals to quickly, easily, and accurately identify the type of work for a given time entry. Work for a construction project may be broken down into different categories and sub-categories of tasks, or action items, that are to be completed. Each such task is typically associated with a unique identifier that serves to define the specific type of work that the task involves. A unique identifier may take the form of a numeric or alphanumeric code, referred to herein as a “cost code,” and a construction project may involve a large number (e.g., hundreds or thousands) of such cost codes. A cost code may indicate various types of information in addition to a specific type of work involved in a task, including a project phase associated with the task, a type of cost associated with the task, or budget information associated with the task. In some instances, a cost code may correspond to work breakdown structure (“WBS”) information for the project and may thus also be referred to as a WBS code. At the time of creating a new time entry, the existing technology requires a construction professional to select, from a listing of the hundreds or thousands of cost codes that are available for the construction project, a particular cost code that defines the specific type of work for which the new time entry is being created. This process can be inconvenient, tedious, and error-prone, as it forces the construction professional to identify the specific cost code by either recalling it from memory, referencing other material (e.g., a previously-created time entry, instructions for creating time entries and identifying cost codes, etc.), or manually filtering through and/or searching for a specific cost code from the listing of the hundreds or thousands of cost codes. Construction professionals may perform various types of work throughout the duration of a construction project, and keeping track of the respective cost code that corresponds to each specific type of work that is performed can be cumbersome and frustrating.

To help address these and other problems, disclosed herein is new software technology that improves upon existing solutions for managing timekeeping for a construction project. In particular, the disclosed software technology is directed to facilitating creation of new time entries and identifying recommended cost codes for the new time entries.

At a high level, the disclosed software technology may function to (i) apply data analytics to initial user-defined information for a new time entry and obtained contextual information and thereby identify one or more recommended cost codes for the new time entry, (ii) receive additional user-defined information that includes a given cost code that has been selected from the recommended cost code(s), and (iii) create the new time entry comprising the given cost code, among various other functions that are performed by the disclosed software technology and are described in further detail below.

The initial user-defined information may include (i) date information for work performed and (ii) identifying information for at least one individual who performed the work. The initial user-defined information may have been provided in various ways. As one possibility, the initial information may have been provided by a user via a graphical user interface (GUI) displayed at a client device, which the user may have interacted with to access a software application incorporating the disclosed technology and being run by a back-end computing platform. The user may have then accessed a software tool for creating new time entries. The software tool that enables creation of new time entries may include one or more GUI views that enable the user to provide user input indicating a request to create the new time entry and may also enable the user to provide date information for the new time entry.

After the user has inputted the request to create the new time entry including the date information, the user may be presented with information that enables identification of at least one individual that performed the work for the new time entry. The user may then confirm the identification of the one or more individuals who performed work for the time entry by selecting a GUI element indicating that the user's selection is complete.

After receiving an indication that the user has completed identifying the one or more individuals, the client device may transmit the communication that includes the initial user-defined information for the new time entry to the back-end computing platform to facilitate the process of determining one or more recommended cost codes for the new time entry. In turn, the back-end computing platform may obtain contextual information related to the initial user-defined information that may be used during data analysis as part of determining one or more recommended cost codes for the new time entry. The contextual information may take various forms, including schedule information for the construction project, project phase information, budget information, work breakdown structure information, information related to the at least one individual identified in the initial user-defined information, or other project information that is accessible to the back-end computing platform, among other possibilities.

The back-end computing platform may then determine a set of one or more recommended cost codes for the new time entry. The function of determining the set of one or more recommended cost codes may take various forms. In at least some implementations, the back-end computing platform may utilize one or more data analytics operations that serve to analyze some set of information for the new time entry, which may comprise a portion of (i) the user-defined information and (ii) the contextual information, and then predict which one or more cost codes are most appropriate for the new time entry based on that analysis. Such a data analytics operation may take various forms. As one possibility, a data analytics operation carried out by the back-end computing platform to determine which one or more cost codes to recommend may be embodied in the form of a user-defined set of one or more rules that is applied to the set of information for the new time entry and outputs a determination of which one or more cost codes to recommend for the new time entry.

As another possibility, a data analytics operation carried out by back-end computing platform to determine which one or more cost codes to recommend may be embodied in the form of a data science model that receives a particular set of information as input and then outputs a determination of one or more recommended cost codes for the new time entry. The data science model may comprise a machine-learning model that has been trained based on historical data regarding time entries using any one or more machine learning techniques now known or later developed.

In one example, the machine-learning model may be a multi-class classification model. The machine-learning model may be configured to receive input information comprising at least a portion of (i) the user-defined information and (ii) the obtained contextual information. In one example, the input information may include all of the user-defined information and the contextual information. In another example, the input information may include a portion of one or both of the user-defined information or the contextual information. For instance, in practice, certain types of information may have more influence or weight (compared to other types of information) with respect to determining which of the available cost codes (e.g., hundreds or thousands of cost codes) are relevant to the new time entry. The machine-learning model may be configured to evaluate the input information and based on the evaluation, render predictions regarding the applicability or suitability of different cost code options that are represented in the form of output data. As one possibility, the output data may comprise a respective likelihood value (or the like) for each cost code option in the universe of cost codes that are available to be included in the new time entry. Each respective likelihood value may provide a measure of likelihood that a cost code option is relevant to the new time entry (i.e., a measure of how applicable or suitable the potential cost code option is predicted to be for the new time entry).

In another example, the machine-learning model may comprise a plurality of binary classification models that are each configured to (i) receive input information for a new time entry, evaluate the input information, and then based on the evaluation, output a prediction that takes the form of a predicted likelihood that a given cost code is applicable or suitable for the new time entry.

Further, the data science model may also apply post-processing logic that functions to interpret the output data of the machine-learning model in order to determine which cost code(s), if any, to recommend for the new time entry. The post-processing logic may take various forms. As one possibility, the post-processing logic may function to identify a set of recommended one or more cost codes using a ranking-based approach. As another possibility, the post-processing logic may function to identify a set of recommended one or more cost codes using a threshold-based approach. As yet another possibility, the post-processing logic may function to (i) identify whichever cost code that has a highest likelihood as a single recommended cost code for the new time entry, so long as that cost code's likelihood value exceeds a threshold value, and (ii) if there are no cost codes having a likelihood value that exceeds the threshold value, do not identify any cost codes that are to be recommended for the new time entry (in which case the new time entry may be assigned a cost code based solely on user input and not any recommendation by the back-end computing platform). Further, as another possibility, the post-processing logic may function to identify a set of recommended one or more cost codes using a hybrid of the ranking-based, threshold-based, or other approaches.

In either case of a data analytics operation embodied in the form of a user-defined set of rules or a data analytics operation embodied in the form of a data science model, the one or more cost codes that are recommended by the data analytics operation could comprise either a single cost code that is deemed to be most applicable to the new time entry or a set of multiple cost codes that are each deemed to be sufficiently applicable for the new time entry, among other possibilities.

After determining the one or more recommended cost codes for the new time entry, the back-end computing platform may transmit, to a client device, a communication identifying the one or more recommended cost codes for the new time entry and thereby cause a visual representation of each recommended cost code to be presented at a GUI displayed by the client device. In addition to the visual representation of each recommended cost code, the back-end computing platform may cause the client device to display one or more fields for inputting additional user-defined information related to the new time entry, thereby enabling the user to provide user input comprising (i) a selection of a given cost code and (ii) the additional user-defined information for the new time entry.

Thereafter, the back-end computing platform may receive, from the client device, a second communication comprising the selected given cost code and the additional user-defined information for the new time entry. In turn, the back-end computing platform may create the new time entry that includes the selected given cost code and the additional user-defined information, which may involve storing a data record of the new time entry along with information about the selected given cost code and the additional user-defined information. The back-end computing platform may optionally cause a representation of the newly created time entry to be presented to the user.

Accordingly, in one aspect, disclosed herein is a method that involves a computing system (1) receiving, from a client device associated with a user, a first communication comprising an initial set of user-defined information for a new time entry related to a construction project, wherein the initial set of user-defined information includes (i) a date for the new time entry and (ii) identifying information for at least one individual working on the construction project; (2) after receiving the initial set of user-defined information for the new time entry, obtaining contextual information related to the at least one individual's work on the construction project; (3) based at least on the initial set of user-defined information and the contextual information related to the at least one individual's work on the construction project, identifying a set of one or more recommended cost codes for the new time entry; (4) causing the client device to display the set of one or more recommended cost codes to the user; (5) receiving, from the client device, a second communication comprising an additional set of user-defined information for the time entry that includes a given cost code that has been selected from the one or more recommended cost codes; and (6) based at least on the initial set of user-defined information and the additional set of user-defined information, creating the new time entry comprising the given cost code.

In another aspect, disclosed herein is a computing system that includes a network interface, at least one processor, a non-transitory computer-readable medium, and program instructions stored on the non-transitory computer-readable medium that are executable by the at least one processor to cause the computing system to carry out the functions disclosed herein, including but not limited to the functions of the foregoing method.

In yet another aspect, disclosed herein is a non-transitory computer-readable storage medium having program instructions stored thereon that are executable to cause a computing system to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts an example computing platform that may be configured to carry out one or more of the functions in accordance with aspects of the disclosed software technology.

FIG. 3 depicts an example process for identifying recommended cost codes for a new time entry in accordance with aspects of the disclosed software technology.

FIG. 4A depicts an example snapshot of a GUI view that may enable creation of a new time entry in accordance with aspects of the disclosed software technology.

FIG. 4B depicts an example snapshot of a GUI view that may enable identification of at least one individual for a new time entry in accordance with aspects of the disclosed software technology.

FIG. 4C depicts an example snapshot of a GUI view that includes identification of at least one individual for a new time entry in accordance with aspects of the disclosed software technology.

FIG. 5 depicts an example structural diagram of a data science model that is configured to identify one or more cost codes for a new time entry in accordance with aspects of the disclosed software technology.

FIG. 6A depicts an example snapshot of a GUI view that may enable presentation of one or more recommended cost codes for a new time entry that have been identified in accordance with aspects of the disclosed software technology.

FIG. 6B depicts an example snapshot of a GUI view that includes one or more recommended cost codes for a new time entry that have been identified in accordance with aspects of the disclosed software technology.

FIG. 7 an example client device that may be configured to communicate with the example computing platform of FIG. 2 in accordance with aspects of the disclosed software technology.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. Example System Configuration

The present disclosure is generally directed to software technology for managing time entries. At a high level, the disclosed software technology may function to (i) apply data analytics to initial user-defined information for a new time entry and obtained contextual information and thereby identify one or more recommended cost codes for the new time entry, (ii) receive additional user-defined information that includes a given cost code that has been selected from the recommended cost code(s), and (iii) create the new time entry comprising the given cost code, among various other functions that are performed by the disclosed software technology and are described in further detail below. This disclosed software technology may be incorporated into one or more software applications that may take any of various forms.

As one possible implementation, this software technology may be incorporated into a software as a service (“SaaS”) application that includes both front-end software running on one or more client devices that are accessible to individuals associated with construction projects (e.g., contractors, subcontractors, project managers, architects, engineers, designers, etc., each of which may be referred to generally herein as a “construction professional”) and back-end software running on a back-end computing platform (sometimes referred to as a “cloud” platform) that interacts with and/or drives the front-end software, and which may be operated (either directly or indirectly) by the provider of the front-end software. As another possible implementation, this software technology may be incorporated into a software application that takes the form of front-end client software running on one or more client devices without interaction with a back-end computing platform. The software technology disclosed herein may be incorporated into software applications that take other forms as well. Further, such front-end client software may take various forms, examples of which may include a native application (e.g., a desktop application or a mobile application), a web application running on a client device, and/or a hybrid application, among other possibilities.

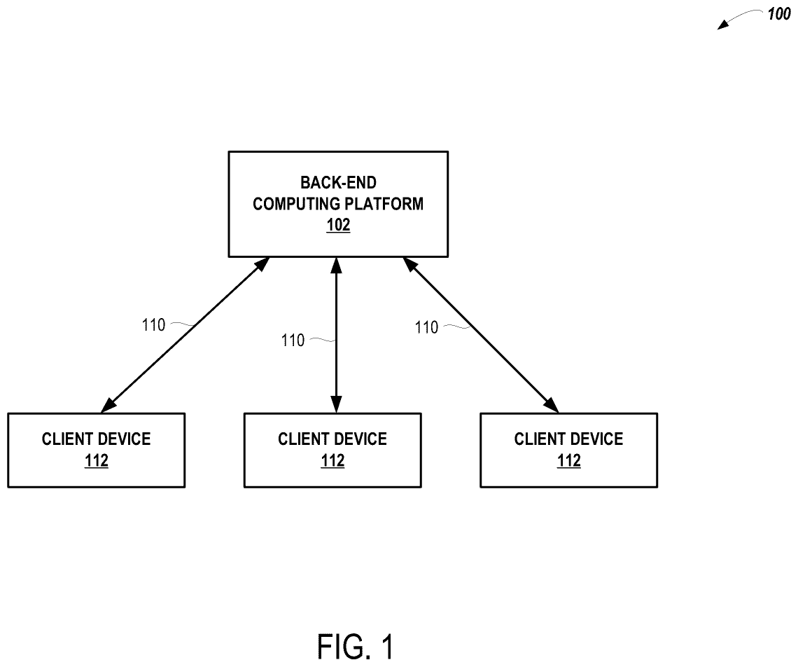

Turning now to the figures, FIG. 1 depicts an example network configuration 100 in which example embodiments of the present disclosure may be implemented. As shown in FIG. 1, network configuration 100 includes a back-end computing platform 102 that may be communicatively coupled to one or more client devices, depicted here, for the sake of discussion, as client devices 112.

Broadly speaking, back-end computing platform 102 may comprise one or more computing systems that have been provisioned with software for carrying out one or more of the functions disclosed herein, including but not limited to functions related to receiving and evaluating user-defined information, obtaining and evaluating contextual information, causing information to be displayed via a front-end interface (e.g., a graphical user interface (GUI)) at the one or more client devices, and facilitating creation and management of time entries. The one or more computing systems of back-end computing platform 102 may take various forms and be arranged in various manners.

For instance, as one possibility, back-end computing platform 102 may comprise computing infrastructure of a public, private, and/or hybrid cloud (e.g., computing and/or storage clusters) that has been provisioned with software for carrying out one or more of the functions disclosed herein. In this respect, the entity that owns and operates back-end computing platform 102 may either supply its own cloud infrastructure or may obtain the cloud infrastructure from a third-party provider of “on demand” computing resources, such as Amazon Web Services (AWS) or the like. As another possibility, back-end computing platform 102 may comprise one or more dedicated servers that have been provisioned with software for carrying out one or more of the functions disclosed herein. Other implementations of back-end computing platform 102 are possible as well.

In turn, client devices 112 may each be any computing device that is capable of running the front-end software disclosed herein. In this respect, client devices 112 may each include hardware components such as a processor, data storage, a communication interface, and user-interface components (or interfaces for connecting thereto), among other possible hardware components, as well as software components that facilitate the client device's ability to run the front-end software incorporating the features disclosed herein (e.g., operating system software, web browser software, mobile applications, etc.). As representative examples, client devices 112 may each take the form of a desktop computer, a laptop, a netbook, a tablet, a smartphone, and/or a personal digital assistant (PDA), among other possibilities.

As further depicted in FIG. 1, back-end computing platform 102 may be configured to interact with client devices 112 over respective communication paths 110. In this respect, each communication path 110 between back-end computing platform 102 and one of client devices 112 may generally comprise one or more communication networks and/or communications links, which may take any of various forms. For instance, each respective communication path 110 with back-end computing platform 102 may include any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path 110 with back-end computing platform 102 may be wireless, wired, or some combination thereof, and may carry data according to any of various different communication protocols. Although not shown, the respective communication paths 110 between client devices 112 and back-end computing platform 102 may also include one or more intermediate systems. For example, it is possible that back-end computing platform 102 may communicate with a given client device 112 via one or more intermediary systems, such as a host server (not shown). Many other configurations are also possible.

While FIG. 1 shows an arrangement in which three particular client devices are communicatively coupled to back-end platform 102, it should be understood that this is merely for purposes of illustration and that any number of client devices may communicate with back-end platform 102.

Although not shown in FIG. 1, back-end computing platform 102 may also be configured to receive data, such as data related to a construction project, from one or more external data sources, such as an external database and/or one or more other back-end computing platforms. Such data sources—and the data output by such data sources—may take various forms.

It should be understood that network configuration 100 is one example of a network configuration in which embodiments described herein may be implemented. Numerous other arrangements are possible and contemplated herein. For instance, other network configurations may include additional components not pictured and/or more or less of the pictured components.

### II. Example Computing Platform

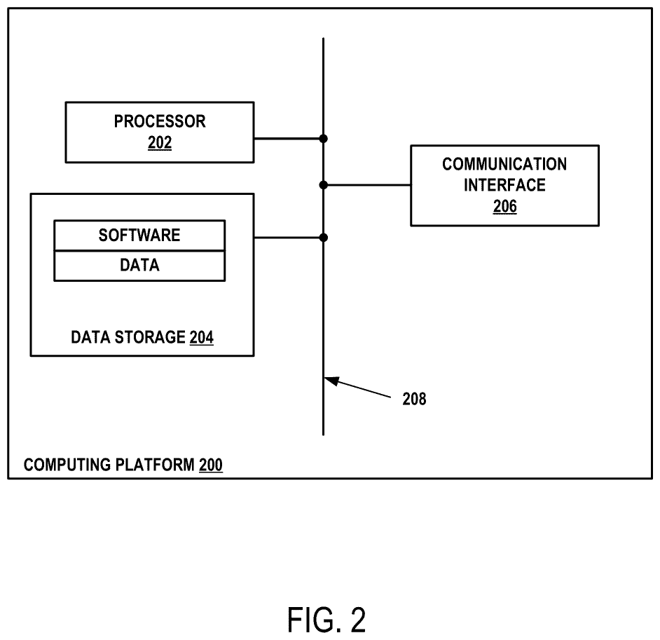

FIG. 2 is a simplified block diagram illustrating some structural components that may be included in an example computing platform 200, which could serve as, for instance, the back-end computing platform 102 of FIG. 1. In line with the discussion above, the computing platform 200 may generally comprise one or more computer systems (e.g., one or more servers), and these one or more computer systems may collectively include at least a processor 202, a data storage 204, and a communication interface 206, all of which may be communicatively linked by a communication link 208 that may take the form of a system bus, a communication network such as a public, private, or hybrid cloud, or some other connection mechanism.

The processor 202 may comprise one or more processor components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that the processor 202 could comprise processing components that are distributed across a plurality of physical computing devices connected via a network, such as a computing cluster of a public, private, or hybrid cloud.

In turn, the data storage 204 may comprise one or more non-transitory computer-readable storage mediums that are collectively configured to store (i) program instructions that are executable by the processor 202 such that computing platform 200 is configured to perform some or all of the functions disclosed herein, which may be arranged together into software applications, virtual machines, software development kits, toolsets, or the like, and (ii) data that may be received, derived, or otherwise stored, for example, in one or more databases, file systems, or the like, by the computing platform 200 in connection with the disclosed functions. In this respect, the one or more non-transitory computer-readable storage mediums of the data storage 204 may take various forms, examples of which may include volatile storage mediums such as random-access memory, registers, cache, etc., and non-volatile storage mediums such as read-only memory, hard-disk drive(s), solid-state drive(s), flash memory, or optical-storage device(s), etc. In line with the discussion above, it should also be understood that the data storage 204 may comprise computer-readable storage mediums that are distributed across a plurality of physical computing devices connected via a network, such as a storage cluster of a public, private, or hybrid cloud. The data storage 204 may take other forms and/or store data in other manners as well.

The communication interface 206 may be configured to facilitate wireless and/or wired communication with external data sources and/or client devices, such as one or more client devices 112 of FIG. 1. Additionally, in an implementation where the computing platform 200 comprises a plurality of physical computing devices connected via a network, the communication interface 206 may be configured to facilitate wireless and/or wired communication between these physical computing devices (e.g., between computing and storage clusters in a cloud network). As such, the communication interface 206 may facilitate communications according to any of various communications protocols, examples of which may include Ethernet, serial bus (e.g., Firewire, USB 3.0, etc.), Wi-Fi, cellular network, short-range wireless protocols, and/or any other communication protocol that provides for wired and/or wireless communication. The communication interface 206 may also include multiple communication interfaces of different types. Other configurations are possible as well.

Although not shown, the computing platform 200 may additionally include or have one or more interfaces for connecting to user-interface components that facilitate user interaction with the computing platform 200, such as a keyboard, a mouse, a trackpad, a display screen, a touch-sensitive interface, a stylus, a virtual-reality headset, and/or speakers, among other possibilities, which may allow for direct user interaction with the computing platform 200.

It should be understood that the computing platform 200 is one example of a computing platform that may be used with the embodiments described herein. Numerous other arrangements are possible and contemplated herein. For instance, other computing platforms may include additional components not pictured and/or more or fewer of the pictured components.

### III. Example Operations

As mentioned above, disclosed herein is new software technology that improves upon existing software technology for managing time entries for work performed on construction projects. In particular, the disclosed technology is directed to facilitating creation of new time entries and recommending a set of one or more relevant cost codes for the new time entries based on applying data analytics to one or more of (i) a date on which work was performed, (ii) information identifying at least one individual who performed the work on that date, and (iii) contextual information related to the date and/or the at least one individual.

The disclosed software technology comprises various aspects that may be implemented either individually or in combination, which will now be described in further detail. Further, in practice, the disclosed software technology may be incorporated into any software application that facilitates timekeeping management and tracking, including but not limited to a construction management software application. Moreover, the disclosed software technology may be actuated by a back-end computing platform, such as the back-end computing platform 102 discussed above with reference to FIG. 1, that is configured to run the software application which incorporates the disclosed software technology.

In accordance with the disclosed technology, the back-end computing platform 102 may be configured to facilitate creation of new time entries for work that is performed on a construction project and recommend a set of one or more cost codes for the new time entries based on (i) a date for the time entry and (ii) identifying information about at least one individual.

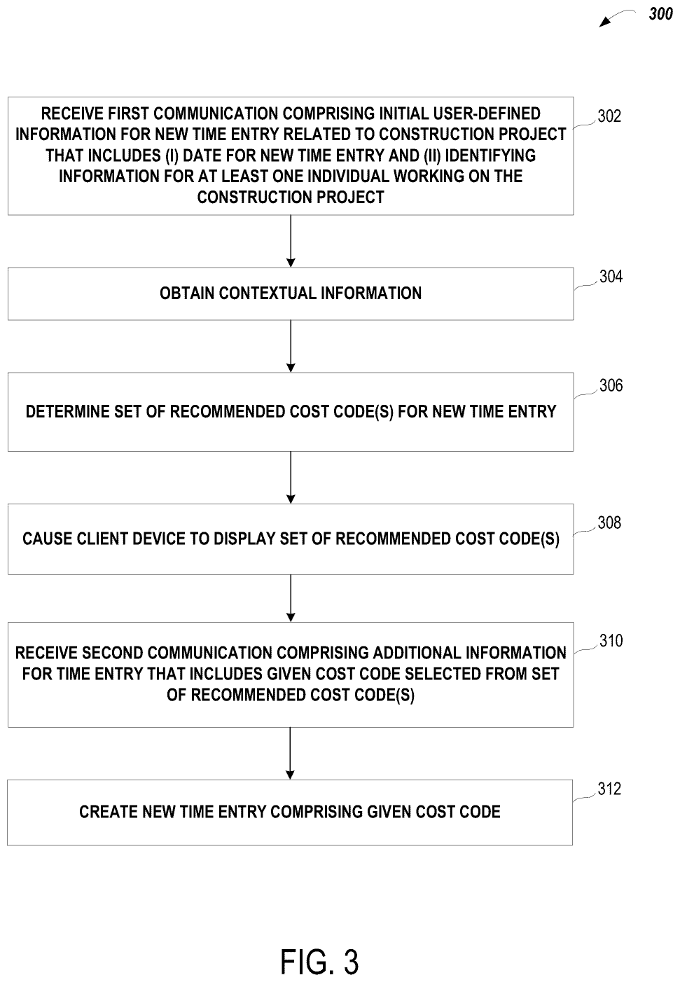

FIG. 3 depicts one example of a process 300 that may be carried out in accordance with the disclosed technology in order to recommend a set of one or more cost codes for a new time entry. For purposes of illustration only, the example process 300 is described as being carried out by the back-end computing platform 102 shown FIG. 1, but it should be understood that the example process 300 may be carried out by one or more computing platforms that take other forms or may be jointly carried out by the back-end computing platform 102 and one or more client devices 112 as well. Further, it should be understood that, in practice, the functions described with reference to FIG. 3 may be encoded in the form of program instructions that are executable by one or more processors of the back-end computing platform 102 and/or the client device(s) 112. Further yet, it should be understood that the disclosed process for recommending one or more cost codes for a new time entry is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

The process 300 may begin at block 302, where the back-end computing platform 102 may receive, from a client device 112 that is associated with a user, a communication comprising initial user-defined information for a new time entry for work performed on a construction project, wherein the initial information includes (i) date information for the work performed and (ii) identifying information for at least one individual who performed the work. The initial user-defined information may have been provided in various ways.

As one possibility, the initial information may have been provided by the user via a graphical user interface (GUI) displayed at the client device 112, which the user may have interacted with to access a software application incorporating the disclosed technology and being run by the back-end computing platform 102. The user may have then accessed a software tool for creating new time entries. Such a software tool may take any of various forms. For instance, the construction management software application offered by Procore Technologies, Inc. includes various software tools that facilitate creation of new time entries (and perhaps also facilitate auto-population of new time entries with relevant information), some examples of which include a “Timecard” software tool for managing employee-specific time entries, a “Timesheets” software tool for managing project-specific time entries, a “Daily Log” software tool for managing day-specific information related to labor, communication, equipment, materials, and site events for a given construction project, a Request for Information (“RFI”) tool for creating and/or managing RFIs, or software tools for providing visual data (e.g., images, videos, etc.), audio data, audio visual data, or sensor data to the back-end computing platform 102. Examples of other software tools that may facilitate creation of new time entries are also possible.

The software tool that enables creation of new time entries may include one or more GUI views that enable the user to provide user input indicating a request to create the new time entry. For instance, the user may select a GUI element, such as a selectable “Add” GUI button or a selectable “plus sign” GUI icon to request creation of the new time entry. The GUI may also enable the user to provide date information for the new time entry. In some implementations, the user may be prompted to first provide date information for the new time entry and then provide the user input to request creation of the new time entry. In other implementations, the user may be prompted to provide the date information after providing the user input to request creation of the new time entry. The manner in which the date information may be provided may take various forms, such as a text input representing a given date, selection of a given date from a listing of one or more dates, or selection of a given date from a calendar view, among other examples. In still further implementations, the date information may be automatically populated with the current date when the user initiates the software tool that facilitates the new time entry, and thus the user input indicating the request to create the new time entry may provide the user-defined date information, by virtue of the user electing to create the time entry for the current date.

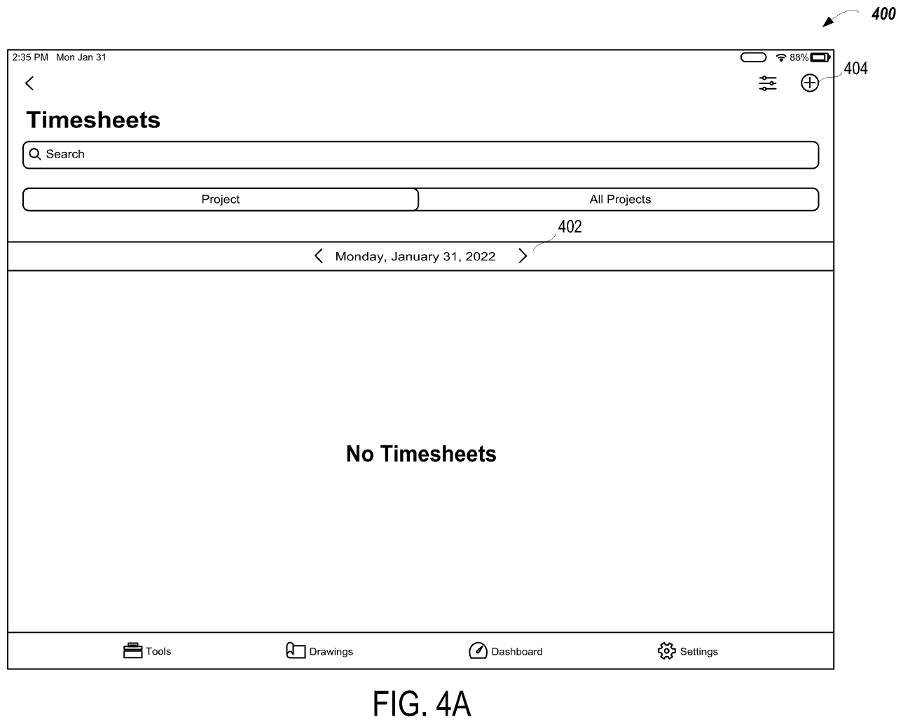

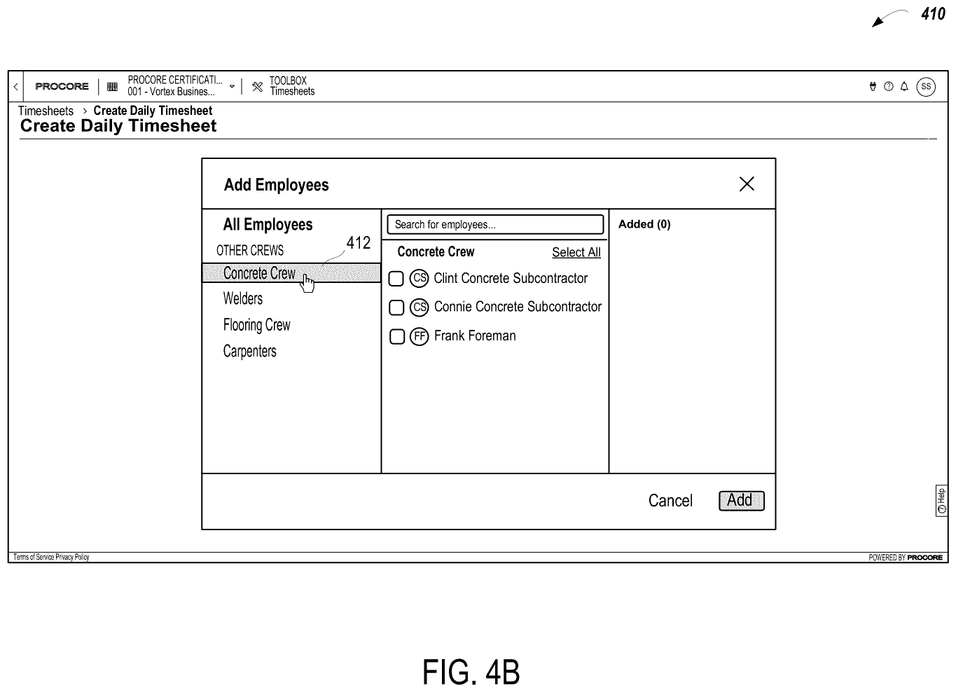

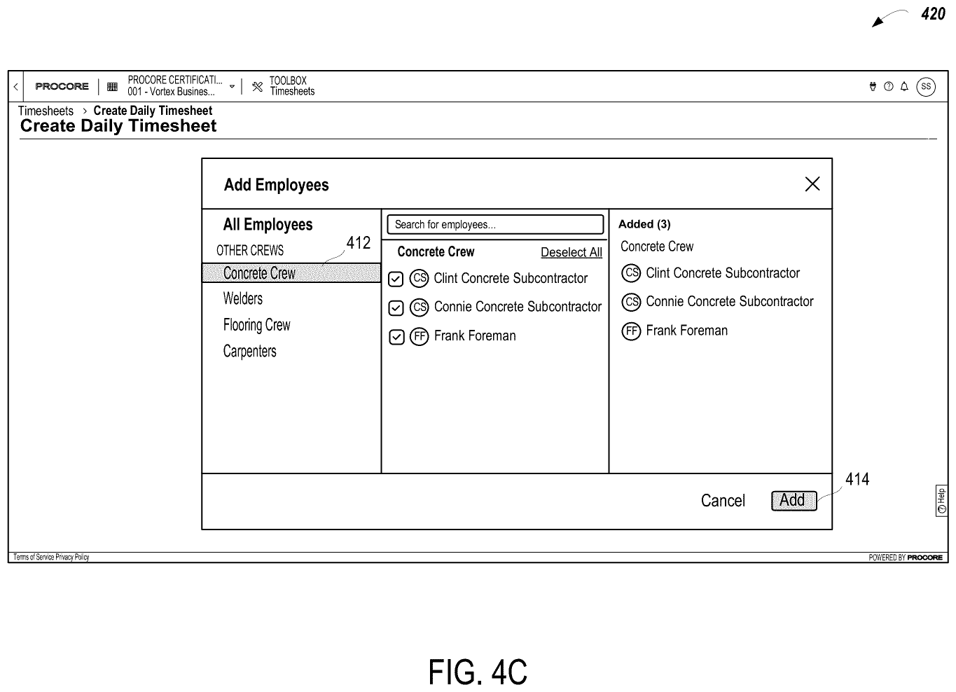

FIG. 4A depicts an example snapshot 400 of a GUI view that may be displayed at the client device 112 after a user has accessed a software tool for creating a new time entry. As shown in FIG. 4, the user may access a “Timesheets” tool for creating a new time entry and thus be presented with the snapshot 400. Using a date selection GUI element 402, the user may adjust a date for the new time entry. The user may then select a GUI element 404 to request creation of the new time entry. As shown in FIG. 4A, the GUI element 404 may take the form of an add sign icon, but it should be understood that the GUI element 404 may take various other forms as well.

After the user has inputted the request to create the new time entry including the date information, the user may be presented with information that enables identification of at least one individual that performed the work for the new time entry. The information that enables the identification of the at least one individual may be based on various factors. As one possibility, the information may be based on a permission level associated with the user. For example, a first permission level, such as baseline “standard”-level permissions, may be assigned to any construction professional who is a user of the software application and may provide permissions for the user to create and manage time entries for work performed by that user. As another example, a second permission level, such as advanced “administrator”-level permissions, may be assigned to any construction professional who is responsible for overseeing work (e.g., project manager, foreman, general contractor, etc.) performed by one or more other construction professionals and may provide permissions for the user to create and manage time entries for not only work performed by that user but also for work performed by other construction professionals within that user's purview. The administrator permissions may provide access to additional time-entry related features as well, such as enabling a user to create, edit, or manage two or more time entries at once in “bulk.” Other permission levels are also possible.

The manner in which the information that enables the identification of the at least one individual is presented to the user may take various forms. As one possibility, in an implementation where the user has standard permissions, the information may take the form of a selectable representation of an identifier of the user. The selectable representation may take various forms, such as a textual label of the user's name accompanied by a selectable checkbox or radio button, or a drop-down menu including a selectable representation of the user's name, among other possibilities. As another possibility, in another implementation where the user has standard permissions, the user may be identified automatically (e.g., by default) as the at least one individual that performed the work for the new time entry. The user may optionally be prompted to confirm that the user is the at least one individual that performed the work for the new time entry.

As yet another possibility, in an implementation where the user has administrator permissions, the information may take the form of selectable representations of respective identifiers of one or more construction professionals that the user is responsible for managing and/or one or more construction crews associated with one or more construction professionals that the user is responsible for managing. For instance, the information may include a first set of selectable representations of the one or more construction professionals and a second set of selectable representations of the one or more construction crews, whereby the user may toggle between each set to view and/or select one or more options from a given set. Further, the selectable representations may take various forms. The information may take other forms as well. The user may then confirm the identification of the one or more individuals who performed work for the time entry by selecting a GUI element indicating that the user's selection is complete.

It should be understood that an “individual” or a “construction professional” that may be identified as having performed work for the construction project may comprise any entity that is capable of performing work, which may include, in addition to a human individual, a machine (e.g., a drone, a robot, an automated excavator, a brick laying machine, etc.), or some other non-human entity.

FIG. 4B depicts an example snapshot 410 of a GUI view including information that enables identification of at least one individual that may be displayed to a user with administrator permissions. As shown in FIG. 4B, the user may be displayed with options for viewing information about “Employees” or “Crews” that the user is responsible for managing. In the example of FIG. 4B, the user may have selected an option to view the concrete crew 412 in order to be presented with information about each member of the concrete crew 412 along with a respective checkbox for each crew member that can be selected to add the crew member to the new time entry. FIG. 4C depicts an example snapshot 420 of a GUI view after the user has selected each crew member of the concrete crew 412, as shown by checkmarks present in the respective checkboxes for the crew members. The user may then select the “Add” GUI button 414 to confirm the selections and add the members of the concrete crew 412 to the new time entry.

After receiving an indication that the user has completed identifying the one or more individuals, the client device 112 may transmit the communication that includes the initial user-defined information for the new time entry, which is received by the back-end computing platform 102 at block 302 of FIG. 3 and used to facilitate the process of determining one or more recommended cost codes for the new time entry.

Returning to FIG. 3, at block 304, the back-end computing platform 102 may obtain contextual information related to the initial user-defined information that may be used later during data analysis by the back-end computing platform 102 as part of the process of determining one or more recommended cost codes for the new time entry. The contextual information may take various forms.

As one possibility, the contextual information may comprise schedule information for the construction project. For instance, a master schedule or a look-ahead schedule for the construction project may define specific work that was scheduled to be performed on or around the user-defined date for the time entry. Such information may be used to identify specific cost codes that are relevant to the new time entry based on specific work that was scheduled on or around the date for the new time entry. As another possibility, the contextual information may comprise project phase information that identifies a project phase (development, pre-construction, construction, etc.) that the construction project was in on or around the user-defined date for the time entry. Each project phase may have associated categories of work that is to be performed during that phase. Such information may be used to identify specific cost codes that are relevant to the new time entry based on the type of work that is scheduled to be performed during a given project phase. As yet another possibility, the contextual information may include budget information for the construction project. For instance, a budget for the construction project may define estimated costs for the work that is to be performed for the construction project. Such information may be used to identify specific cost codes that are relevant to the new time entry based on the estimated work costs that have been budgeted for the construction project. Still, as another possibility, the contextual information may include work breakdown structure information for the construction project. For instance, a work breakdown structure for the construction project may include detailed information defining all of the work activities that are to be completed for the construction project, including budget and cost information for each work activity. Such information may be used to identify specific cost codes that are relevant to the new time entry based on work activities that are defined for the construction project.

As yet another possibility, the contextual information may include information related to the at least one individual identified in the initial user-defined information. As one example, the contextual information may include information about a given construction professional's role with respect to the construction project, which may be used to identify specific cost codes that are relevant to the new time entry based on the type of work that the given construction professional is likely to perform for the construction project. For instance, if the construction professional is a painter and/or a member of a paint crew, then it may be likely that the construction professional performed paint-related work, whereas if the construction professional is a concrete worker and/or a member of a concrete crew, then it may be likely that the construction professional performed concrete-related work. As another example, the contextual information may include location information related to the at least one individual identified in the initial user-defined information, such as a site location at which specific work was scheduled to be performed by the at least one individual on or around the date for the new time entry.

Still, as another possibility, the contextual information may include any other project information that is accessible to the back-end computing platform 102 that may provide additional context about the type of work that was performed by the at least one individual identified in the initial user-defined information on or around the date for the new time entry and may thus be used to identify specific cost codes that are relevant to the new time entry. Some examples of such project information may include information that was previously-entered using one or more other software tools of the software application, such as bid information (e.g., information that the at least one individual was hired to perform specific work for the construction project), observation entries (e.g., notes, observations, or incident reports that a given construction professional recorded while on-site), change event information (e.g., a change order that a given construction professional requested based on an observation made on or near the date for the new time entry), daily log information (e.g., information about work progress, obstacles, incidents, weather reports, etc.), images, videos, or other audiovisual data, sensor data, or previously-created time entries, among other possibilities.

The contextual information may include other types of information as well.

In some implementations, some contextual information may be included in the first communication received by the back-end computing platform 102 at block 302. For example, the first communication may include photo or video data, and the back-end computing platform 102 may analyze that data (e.g., using computer vision) to obtain additional contextual information, such as an object or an activity that is discernible from the data, that may facilitate a determination of a recommended cost code(s). In other implementations, the process 300 of FIG. 3 may begin at block 304 with the function of obtaining contextual information for a time entry. For instance, the back-end computing platform 102 may receive photo or video data, analyze that data to obtain contextual information (e.g., project phase information, location information, etc.) that may facilitate a determination of a recommended cost code(s). Further, in some implementations, the back-end computing platform 102 may use certain contextual information to determine other contextual information. For example, the back-end computing platform 102 may obtain image, video, or audio data that may be analyzed to determine a possible location for the time entry, which may then be recommended to the user for association with the time entry.

Advantageously, supplementing a time entry with contextual information as described above may be useful for tracking and/or analyzing performance metrics related to work performed on a construction project. For instance, time entry information may be aggregated in order to extract net performance metrics based on one or more attributes, such as location or cost code, etc. For example, aggregated time entry information indicating (i) a given location where work was performed, (ii) the recommended cost code for the work performed (the process for recommending cost codes will be discussed further below, (iii) total time spent to complete that work, and (iv) individuals that performed that work, can provide insight about work performance and costs incurred for work at the given location. This may be particularly useful for benchmarking, goal-setting, and increasing efficiency (e.g., comparing performance metrics based on time entry information for work performed on a first floor of a building with work performed on a second floor of the building may provide insight about how work performance may be improved on other floors of the building).

At block 306, the back-end computing platform 102 may determine a set of one or more recommended cost codes for the new time entry. The function of determining the set of one or more recommended cost codes may take various forms. In at least some implementations, the back-end computing platform 102 may utilize one or more data analytics operations that serve to analyze some set of information for the new time entry, which may comprise a portion of (i) the user-defined information and (ii) the contextual information, and then predict which one or more cost codes are most appropriate for the new time entry based on that analysis. Such a data analytics operation may take various forms.

As one possibility, a data analytics operation carried out by the back-end computing platform 102 to determine which one or more cost codes to recommend may be embodied in the form of a user-defined set of one or more rules that is applied to the set of information for the new time entry and outputs a determination of which one or more cost codes to recommend for the new time entry. In general, any suitable rule(s) to determine which one or more cost codes to recommend may be utilized. Further, in practice, the user-defined rules that are used to determine which one or more cost codes to recommend could be defined by the software application provider, users of the software application, industry-defined standards, or some combination thereof. Further yet, the user-defined rules that are used to determine which one or more cost codes to recommend may be adjusted based on factors such as the specific construction project for which the new time entry is being created or the particular user that is requesting to create the new time entry, among other possibilities.

As another possibility, a data analytics operation carried out by back-end computing platform 102 to determine which one or more cost codes to recommend may be embodied in the form of a data science model that receives a particular set of information as input and then outputs a determination of one or more recommended cost codes for the new time entry. For instance, the data science model may comprise one or more machine-learning models that have been trained based on historical data regarding time entries using any one or more machine learning techniques now known or later developed, examples of which may include any of various supervised learning techniques, such as a neural network technique (which is sometimes referred to as “deep learning”), a regression technique, a k-Nearest Neighbor (kNN) technique, a decision-tree technique, a support vector machines (SVM) technique, a Bayesian technique, an ensemble technique, a clustering technique, an association-rule-learning technique, a dimensionality reduction technique, an optimization technique such as gradient descent, a regularization technique, artificial and/or recurrent neural networks, and/or a reinforcement technique, among other possible types of machine learning techniques.

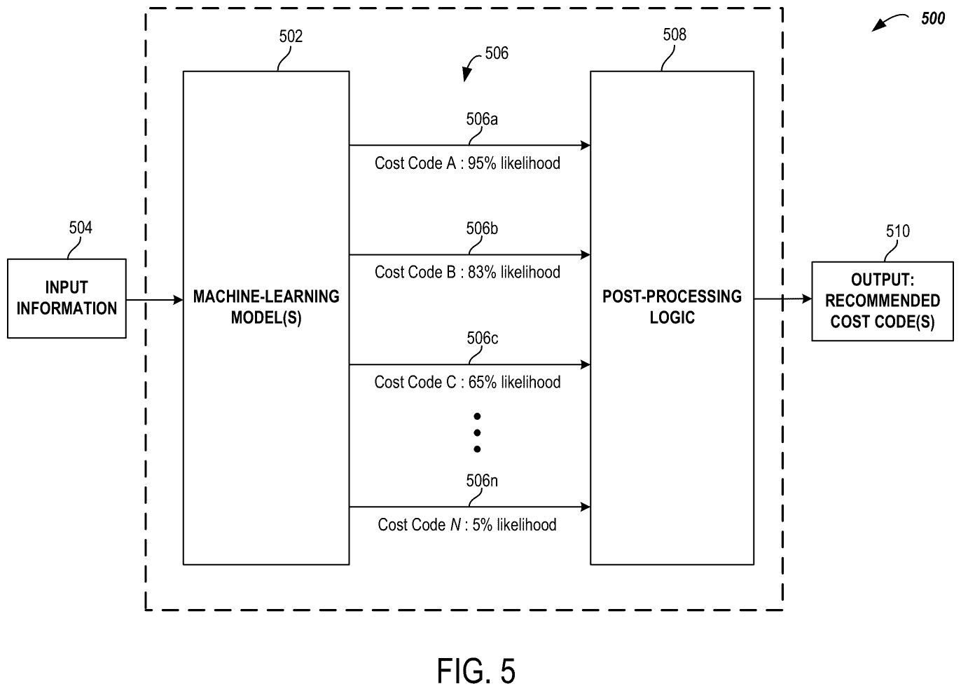

FIG. 5 depicts a conceptual illustration of one example of such a data science model 500 that is configured to determine recommended cost code(s) for a new time entry. In the example of FIG. 5, the data science model 500 may comprise one or more machine-learning models 502 that have been trained based on historical time entry data. The machine-learning model(s) 502 may take various forms. For example, as one possibility, the machine-learning model(s) 502 may be a machine-learning model 502 that is a multi-class classification model. Such a machine-learning model 502 may be configured to receive input information 504. The input information may comprise at least a portion of (i) the user-defined information and (ii) the obtained contextual information. In one example, the input information 504 may include all of the user-defined information and the contextual information. In another example, the input information 504 may include a portion of one or both of the user-defined information or the contextual information. For instance, in practice, certain types of information may have more influence or weight (compared to other types of information) with respect to determining which of the available cost codes (e.g., hundreds or thousands of cost codes) are relevant to the new time entry.

The machine-learning model 502 may be configured to evaluate the input information 504 and, based on the evaluation, render predictions regarding the applicability or suitability of different cost code options that are represented in the form of output data 506. As one possibility, the output data 506 may comprise a respective likelihood value (or the like) for each cost code option in the universe of cost codes that are available to be included in the new time entry. Each respective likelihood value may provide a measure of likelihood that a cost code option is relevant to the new time entry (i.e., a measure of how applicable or suitable the potential cost code option is predicted to be for the new time entry). For instance, the machine-learning model 502 may be configured to predict a likelihood value for each of N potential cost code options. In some implementations, the machine-learning model 502 may be configured to predict a likelihood value for every possible cost code, such that the N potential cost code options may include hundreds or even thousands of cost code options. Alternatively, the machine-learning model 502 may be configured to predict a likelihood value for a predetermined maximum number of cost codes. In this way, the N potential cost code options may correspond to only the most likely cost codes (e.g., 20, 50, etc.), among other possibilities.

As illustrated in FIG. 5, the output data 506 of the machine-learning model 502 includes a first likelihood value 506a for cost code A (which indicates in this example that cost code A has a 95% likelihood of being an appropriate cost code for the new time entry), a second likelihood value 506b for cost code B (which indicates in this example that cost code B has an 83% likelihood of being an appropriate cost code for the new time entry), a third likelihood value 506c for cost code C (which indicates in this example that cost code C has a 65% likelihood of being an appropriate cost code for the new time entry), and a likelihood value 506n for cost code N (which indicates in this example that cost code N has a 5% likelihood of being an appropriate cost code for the new time entry).

The machine-learning model(s) 502 may take other forms as well.

For example, as another possibility, the machine-learning model(s) 502 may comprise a plurality of binary classification models that are each configured to (i) receive input information 504 for a new time entry, evaluate the input information 504, and then based on the evaluation, output a prediction that takes the form of a predicted likelihood that a given cost code is applicable or suitable for the new time entry.

For instance, the machine-learning model(s) 502 may comprise (1) a binary first classification model that is configured to output a first prediction 506a that takes the form of a predicted likelihood that cost code A is appropriate for the new time entry, (2) a second binary classification model that is configured to output a second prediction 506b that takes the form of a predicted likelihood that cost code B is appropriate for the new time entry, (3) a third binary classification model that is configured to output a third prediction 506c that takes the form of a predicted likelihood that cost code A is appropriate for the new time entry, and (4) an nth binary classification model that is configured to output an nth prediction 506n that takes the form of a predicted likelihood that cost code N is appropriate for the new time entry. In such an implementation, the post-processing logic 508 may then comprise either a single, global threshold value that is to be applied to the outputs of all of the binary classification models in order to identify any recommended cost codes for the new time entry, or a model-specific threshold value that is applied to the respective output of each binary classification model outputs in order to identify any recommended cost codes for the new time entry, among other possibilities.

The data science model 500 for identifying recommended cost codes for the new time entry may comprise one or more machine learning models of other types as well, including but not limited to a machine learning model that is created based on unsupervised machine learning techniques, one example of which includes a clustering technique.

Further, the data science model 500 may also apply post-processing logic 508 that functions to interpret output data 506 of the machine-learning model 502 so as to determine which cost code(s), if any, to recommend for the new time entry. The post-processing logic 508 may take various forms.

As one possibility, the post-processing logic 508 may function to identify a set of recommended one or more cost codes using a ranking-based approach. For example, the post-processing logic 508 may rank the cost codes A-N based on their respective likelihood values and then identify some pre-defined, top-ranked number of cost codes as the recommended cost codes, such as the top 1, top 3 or top 5 cost codes, among various other possible cutoffs for the new time entry.

As another possibility, the post-processing logic 508 may function to identify a set of recommended one or more cost codes using a threshold-based approach. For example, the post-processing logic 508 may compare each likelihood value 506a-506n to a threshold value and then identify any cost codes having a likelihood value that meets the threshold value as the recommended cost codes for the new time entry. The threshold value may be any suitable threshold and may be pre-defined in the program code for the data science model 500 or by one or more users of the software application. As one example, if the threshold value is set to an 80% likelihood of suitability, the post-processing logic 508 may identify in the output 510 a set of recommend cost code(s) comprising both cost code A and cost code B. As another example, if the threshold value is set to a 90% likelihood of suitability, the post-processing logic 508 may identify in the output 510 a set of recommend cost code(s) comprising only cost code A.

As yet another possibility, the post-processing logic 508 may function to (i) identify whichever cost code that has a highest likelihood as a single recommended cost code for the new time entry, so long as that cost code's likelihood value exceeds a threshold value, and (ii) if there are no cost codes having a likelihood value that exceeds the threshold value, do not identify any cost codes that are to be recommended for the new time entry (in which case the new time entry may be assigned a cost code based solely on user input and not any recommendation by the back-end computing platform 102). As one example, the post-processing logic 508 may identify cost code A as the recommended cost code if an example threshold value of 90% is used, whereas it may not identify any cost code if an example threshold value of 96% is used. Other example post-processing rules are possible as well.

Further, as another possibility, the post-processing logic 508 may function to identify a set of recommended one or more cost codes using a hybrid of the ranking-based, threshold-based, or other approaches. For example, under a hybrid approach, the post-processing logic 508 may start by preliminarily identifying any cost code having a likelihood value that meets a threshold value, and if there is less than a cutoff number of cost codes that are preliminarily identified, the computing platform may then identify each such cost code as a recommended cost code, whereas if there is more than the cutoff number of cost codes that are preliminarily identified, the post-processing logic 508 may then rank the cost codes that are preliminarily identified based on their likelihood values and then identify some pre-defined number of top-ranked cost codes as the recommended cost codes.

The function of identifying the set of one or more recommended cost codes may take other forms as well.

As mentioned above, in either case of a data analytics operation embodied in the form of a user-defined set of rules or a data analytics operation embodied in the form of a data science model, the one or more cost codes that are recommended by the data analytics operation could comprise either a single cost code that is deemed to be most applicable to the new time entry or a set of multiple cost codes that are each deemed to be sufficiently applicable for the new time entry, among other possibilities.

Returning to FIG. 3, at block 308, the back-end computing platform 102 may transmit, to a client device 112, a communication identifying the one or more recommended cost codes for the new time entry and thereby cause a visual representation of each recommended cost code to be presented at a GUI displayed by the client device 112. In some examples, the client device 112 to which the communication is transmitted may be the same client device 112 that transmitted the initial user-defined information to the back-end computing platform 102. In other examples, the client device 112 that transmitted the initial user-defined information to the back-end computing platform 102 may be a first client device 112, and the client device 112 to which the communication identifying the one or more recommended cost codes is transmitted may be a different, second client device 112. As one possibility, the first client device and the second client device may be different client devices associated with the same user. For instance, the first client device may be a computer or a laptop of the user, and the second client device may be a tablet or a smartphone of the user. As another possibility, the first client device may be a client device associated with a first user, and the second client device may be a client device associated with a different, second user. Other examples are possible as well.

The visual representations of the recommended cost code(s) may be presented in various manners. As one possibility, the visual representations may be presented as a list, such as a drop-down list. As another possibility, the visual representations may be presented in a pop-up GUI pane or window that is overlaid on a GUI view displayed at the client device 112.

Moreover, a visual representation of a set of one or more recommended cost codes may take various forms. In general, the visual representation of each cost code may comprise an indicator that identifies the recommended cost code. The indicator may take various forms, such as a text label, a numerical label, or a combination thereof, among other possibilities. Further, the indicator may be selectable or include a selectable GUI component (e.g., a checkbox, a radio button, etc.) that enables the user to select the respective recommended cost code. In some implementations, where only a single cost code is recommended for the new time entry, a selectable GUI component of the cost code's visual representation may be selected by default such that the user may not need to affirmatively select the GUI component to select the recommended cost code, although the GUI component may be de-selected if the user does not wish to select the recommended cost code.

In some implementations, the visual representation of each recommended cost code may additionally include a selectable GUI element that enables the user to dismiss the recommended cost code (e.g., a “delete” or “X” GUI button, etc.). Additionally, in some implementations, the GUI view may include an input field or other GUI component that enables the user to input a cost code that is different from any recommended cost code. Other examples of visual representations and/or selectable indicators are possible as well.

In addition to the visual representation of each recommended cost code, the back-end computing platform 102 may cause the client device 112 to display one or more fields for inputting additional user-defined information related to the new time entry. Such one or more fields may take any of various forms, including but not limited to selectable drop-down menus, text input fields, numerical input fields, selectable GUI components, or any combination thereof. The additional user-defined information may define various types of information, including but not limited to location information indicating a site where the work for the time entry was performed, information about a quantity or duration of time spent performing the work, billing rate information, whether or not the work is billable against the construction project budget, or notes and/or comments, among other possibilities.

After being presented with the visual representation of each recommended cost code and the one or more fields for inputting the additional user-defined information related to the new time entry as described above, the user may provide user input comprising (i) a selection of a given cost code and (ii) the additional user-defined information for the new time entry.

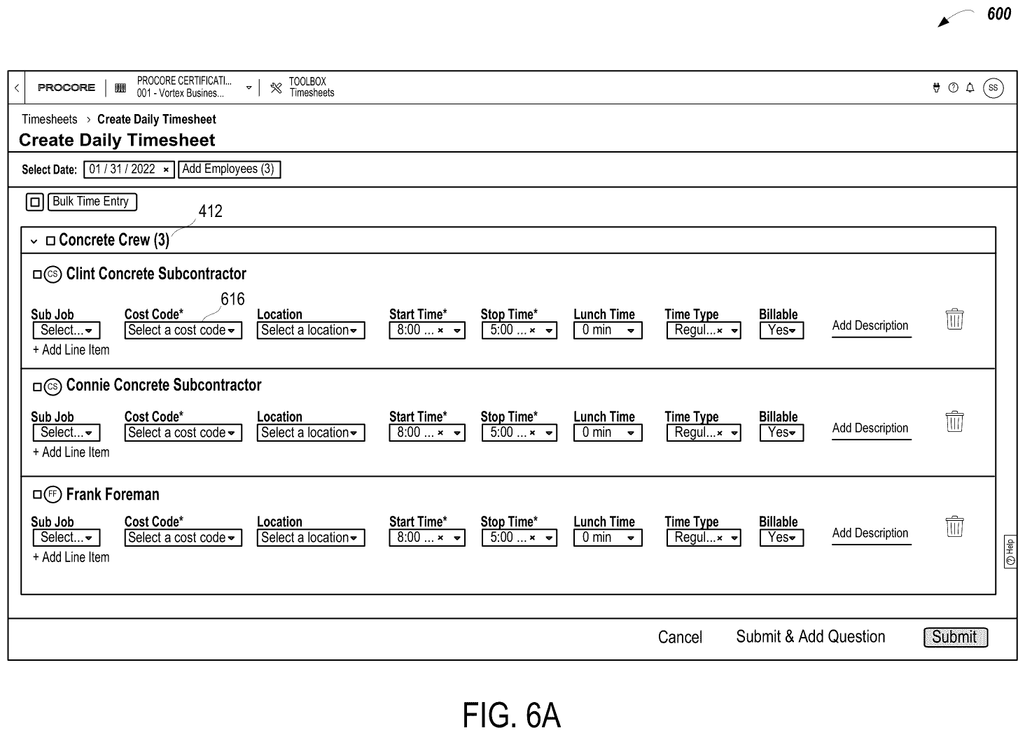

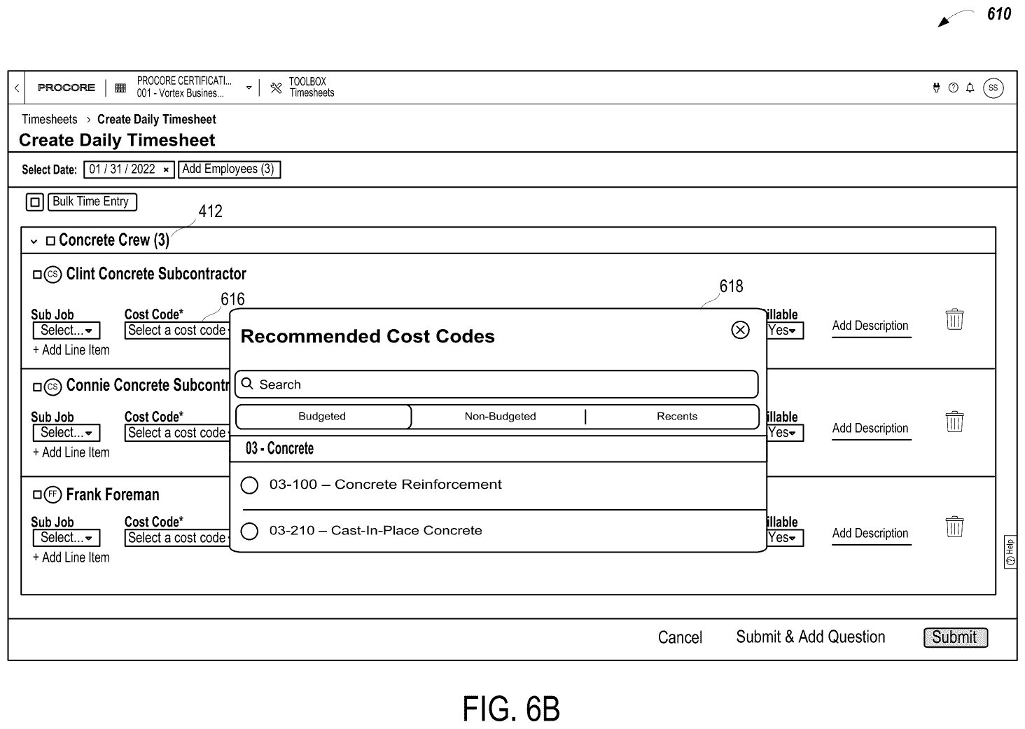

FIG. 6A depicts an example snapshot 600 of a GUI view that may be presented to the user after the back-end computing platform 102 has determined a set of one or more recommended cost codes for a new time entry. The snapshot 600 may be a GUI view that is presented after the initial user-defined information for the new time entry was provided as discussed above with reference to FIGS. 4A-4C. Such initial user-defined information may have included a date for the time entry (i.e., Aug. 22, 2018), and identifying information for at least one individual (i.e., members of the concrete crew 412). In the example of FIG. 6A, the set of recommended cost code(s) determined by the back-end computing platform 102 may be presented in a drop-down menu 616. In some implementations, the set of recommended cost code(s) 610 may be displayed as a new GUI view. In other implementations, the set of recommended cost code(s) 610 may be displayed as a pop-up pane or window that is overlaid onto the snapshot 600 of FIG. 6A. For instance, FIG. 6B depicts an example snapshot 610 of a GUI view that includes a pop-up pane 618 that includes a set of recommended cost codes 618. The example snapshot 610 may be displayed, for example, upon selection of the drop-down menu 616 of FIG. 6A. As shown in FIG. 6B, each recommended cost code in the set of recommended cost codes may have a selectable GUI component, such as a radio button, that can be used to select the recommended cost code as the appropriate cost code for the new time entry. Additionally, as shown in the example of FIG. 6B, the pop-up pane 618 may include an option for the user to manually search for a cost code other than those included in the set of recommended cost codes. In such instances, if the user searches for and selects a cost code that is not a recommended cost code, the back-end computing platform 102 may cause the GUI view to display a notification prompting the user to select from the set of recommended cost codes. In some instances where the user searches for and selects a cost code that is not a recommended cost code, the back-end computing platform 102 may re-run the machine-learning model 502 to determine a new set of recommended cost code(s). Other examples are also possible.

Returning to FIG. 6A, the user may enter data in one or more data fields shown in the snapshot 600 to provide additional user-defined information for the new time entry. Such additional user-defined information may include a location, a start time for when the work commenced, a stop time for when the work concluded, a duration of time for a lunch break, information about billing rates, whether or not the new time entry is billable, and any notes or comments for the time entry that the user wishes to provide. The snapshot 600 may also include selectable GUI icons (e.g., trash can icons) for deleting one or more members of the concrete crew 412. After the user has completed selecting a given recommended cost code and providing the additional user-defined information, the user may confirm the input provided by selecting a “Submit” GUI button.

Returning to FIG. 3, at block 310, the back-end computing platform 102 may receive, from the client device 112, a second communication comprising the selected given cost code and the additional user-defined information for the new time entry. For instance, in the context of FIG. 6A, the client device 112 may transmit the second communication to the back-end computing platform 102 upon selection of the “Submit” button by the user. At block 312, the back-end computing platform 102 may create the new time entry that includes the selected given cost code and the additional user-defined information, which may involve storing a data record of the new time entry along with information about the selected given cost code and the additional user-defined information. The back-end computing platform 102 may optionally cause a representation of the newly created time entry to be presented to the user.

Information about user cost code selection based on cost code recommendations (including both acceptances and rejections of cost code recommendations provided by the back-end computing platform 102) may be provided as training data to the machine-learning model(s) 502 on a recurrent basis, thereby embedding expertise into the model(s) and improving the recommended cost codes that are presented to users.

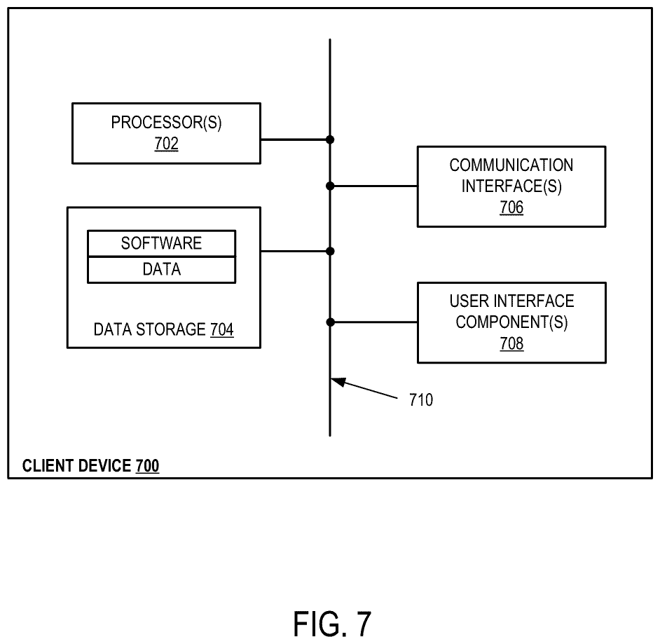

Turning now to FIG. 7, a simplified block diagram is provided to illustrate some structural components that may be included in an example client device 700, such as a client device 112 described above with reference to FIG. 1. As shown in FIG. 7, the client device 700 may include one or more processors 702, data storage 704, one or more communication interfaces 706, and one or more user-interface components 708, all of which may be communicatively linked by a communication link 710 that may take the form of a system bus or some other connection mechanism. Each of these components may take various forms.

The processor(s) 702 may comprise one or more processing components, such as general-purpose processors (e.g., a single- or a multi-core CPU), special-purpose processors (e.g., a GPU, application-specific integrated circuit, or digital-signal processor), programmable logic devices (e.g., a field programmable gate array), controllers (e.g., microcontrollers), and/or any other processor components now known or later developed.

In turn, the data storage 704 may comprise one or more non-transitory computer-readable storage mediums that are collectively configured to store (i) program instructions that are executable by the processor(s) 702 such that the client device 700 is configured to perform certain functions related to interacting with and accessing services provided by a computing platform, such as the example computing platform 200 described above with reference to FIG. 2, and (ii) data that may be received, derived, or otherwise stored, for example, in one or more databases, file systems, repositories, or the like, by the client device 700, related to interacting with and accessing services provided by a computing platform. In this respect, the one or more non-transitory computer-readable storage mediums of the data storage 704 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. The data storage 704 may take other forms and/or store data in other manners as well.

The one or more communication interfaces 706 may be configured to facilitate wireless and/or wired communication with other computing devices. The communication interface(s) 706 may take any of various forms, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

The client device 700 may additionally include or have interfaces for one or more user-interface components 708 that facilitate user interaction with the client device 700, such as a keyboard, a mouse, a trackpad, a display screen, a touch-sensitive interface, a stylus, a virtual-reality headset, and/or one or more speaker components, among other possibilities.

It should be understood that the client device 700 is one example of a client device that may be used to interact with a computing platform as described herein. Numerous other arrangements are possible and contemplated herein. For instance, in other embodiments, the client device 700 may include additional components not pictured and/or more or fewer of the pictured components.

In the ways described above, the disclosed software technology provides several improvements and advantages over existing technology for managing timekeeping for work performed on construction projects.

### CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” “parties,” or other entities, this is for purposes of example and explanation only. Claims should not be construed as requiring action by such actors unless explicitly recited in claim language.

1. A computing system comprising:
a network interface;
at least one processor;
at least one non-transitory computer-readable medium; and
program instructions stored on the at least one non-transitory computer-readable medium that are executable by the at least one processor such that the computing system is configured to:
receive, from a client device associated with a user, a first communication comprising an initial set of user-defined information for a new time entry related to a construction project, wherein the initial set of user-defined information includes (i) a date for the new time entry and (ii) identifying information for at least one individual working on the construction project;
after receiving the initial set of user-defined information for the new time entry, obtain contextual information related to the at least one individual's work on the construction project;
based at least on the initial set of user-defined information and the contextual information related to the at least one individual's work on the construction project, identify a set of one or more recommended cost codes for the new time entry;
cause the client device to display the set of one or more recommended cost codes to the user;
receive, from the client device, a second communication comprising an additional set of user-defined information for the time entry that includes a given cost code that has been selected from the one or more recommended cost codes; and
based at least on the initial set of user-defined information and the additional set of user-defined information, create the new time entry comprising the given cost code.

2. The computing system of claim 1, wherein the identifying information for the at least one individual working on the construction project includes one or more of: (i) an identifier of the at least one individual or (ii) an identifier of a construction crew with which the at least one individual is associated.

3. The computing system of claim 1, wherein the context information includes one or more of: (i) schedule information for the construction project, (ii) phase information for the construction project, (iii) budget information for the construction project, (iv) work breakdown structure information for the construction project, (v) location information for the at least one individual, or (vi) previously-entered information for the construction project or the at least one individual.

4. The computing system of claim 1, wherein the program instructions that are executable by the at least one processor such that the computing system is configured to identify the set of one or more recommended cost codes comprise program instructions that are executable by the at least one processor such that the computing system is configured to:
apply one or more data analytics operations to at least a portion of the initial set of user-defined information and the contextual information and thereby identify the set of one or more recommended cost codes.

5. The computing system of claim 4, wherein the program instructions that are executable by the at least one processor such that the computing system is configured to apply the one or more data analytics operations comprise program instructions that are executable by the at least one processor such that the computing system is configured to:
provide at least a portion of the initial set of user-defined information and the contextual information as input for a rules engine that is configured to apply a set of one or more user-defined rules for determining cost codes and output a recommendation of one or more cost codes for the new time entry.

6. The computing system of claim 4, wherein the program instructions that are executable by the at least one processor such that the computing system is configured to apply the one or more data analytics operations comprise program instructions that are executable by the at least one processor such that the computing system is configured to:
provide at least a portion of the initial set of user-defined information and the contextual information as input for a data science model that is configured to evaluate the input and output, for each possible cost code option, a respective likelihood of suitability with respect to the new time entry.

7. The computing system of claim 6, wherein the data science model comprises a classification model and is further configured to apply one or more post-processing operations and thereby determine the set of one or more recommended cost codes that is to be presented to the user.

8. The computing system of claim 1, wherein the additional set of user-defined information further includes:
a quantity of time for the time entry;
information about a billing rate for the time entry; and
an indication of whether or not the time entry is billable against a budget for the construction project.

9. The computing system of claim 1, wherein the at least one individual comprises the user.

10. At least one non-transitory computer-readable medium, wherein the at least one non-transitory computer-readable medium is provisioned with program instructions that, when executed by at least one processor, cause a computing system to:
receive, from a client device associated with a user, a first communication comprising an initial set of user-defined information for a new time entry related to a construction project, wherein the initial set of user-defined information includes (i) a date for the new time entry and (ii) identifying information for at least one individual working on the construction project;
after receiving the initial set of user-defined information for the new time entry, obtain contextual information related to the at least one individual's work on the construction project;
based at least on the initial set of user-defined information and the contextual information related to the at least one individual's work on the construction project, identify a set of one or more recommended cost codes for the new time entry;
cause the client device to display the set of one or more recommended cost codes to the user;
receive, from the client device, a second communication comprising an additional set of user-defined information for the time entry that includes a given cost code that has been selected from the one or more recommended cost codes; and
based at least on the initial set of user-defined information and the additional set of user-defined information, create the new time entry comprising the given cost code.

11. The at least one non-transitory computer-readable medium of claim 10, wherein the identifying information for the at least one individual working on the construction project includes one or more of: (i) an identifier of the at least one individual or (ii) an identifier of a construction crew with which the at least one individual is associated.

12. The at least one non-transitory computer-readable medium of claim 10, wherein the context information includes one or more of: (i) schedule information for the construction project, (ii) phase information for the construction project, (iii) budget information for the construction project, (iv) work breakdown structure information for the construction project, (v) location information for the at least one individual, or (vi) previously-entered information for the construction project or the at least one individual.

13. The at least one non-transitory computer-readable medium of claim 10, wherein the program instructions that, when executed by the at least one processor cause the computing system to identify the set of one or more recommended cost codes comprise program instructions that, when executed by the at least one processor cause the computing system to:
apply one or more data analytics operations to at least a portion of the initial set of user-defined information and the contextual information and thereby identify the set of one or more recommended cost codes.

14. The at least one non-transitory computer-readable medium of claim 13, wherein the program instructions that, when executed by the at least one processor cause the computing system to apply the one or more data analytics operations comprise program instructions that, when executed by the at least one processor cause the computing system to:
provide at least a portion of the initial set of user-defined information and the contextual information as input for a rules engine that is configured to apply a set of one or more user-defined rules for determining cost codes and output a recommendation of one or more cost codes for the new time entry.

15. The at least one non-transitory computer-readable medium of claim 13, wherein the program instructions that, when executed by the at least one processor cause the computing system to apply the one or more data analytics operations comprise program instructions that, when executed by the at least one processor cause the computing system to:
provide at least a portion of the initial set of user-defined information and the contextual information as input for a data science model that is configured to evaluate the input and output, for each possible cost code option, a respective likelihood of suitability with respect to the new time entry.

16. The at least one non-transitory computer-readable medium of claim 15, wherein the data science model comprises a classification model and is further configured to apply one or more post-processing operations and thereby determine the set of one or more recommended cost codes that is to be presented to the user.

17. The at least one non-transitory computer-readable medium of claim 10, wherein the additional set of user-defined information further includes:
a quantity of time for the time entry;
information about a billing rate for the time entry; and
an indication of whether or not the time entry is billable against a budget for the construction project.

18. A method carried out by a computing system, the method comprising:
receiving, from a client device associated with a user, a first communication comprising an initial set of user-defined information for a new time entry related to a construction project, wherein the initial set of user-defined information includes (i) a date for the new time entry and (ii) identifying information for at least one individual working on the construction project;
after receiving the initial set of user-defined information for the new time entry, obtaining contextual information related to the at least one individual's work on the construction project;
based at least on the initial set of user-defined information and the contextual information related to the at least one individual's work on the construction project, identifying a set of one or more recommended cost codes for the new time entry;
causing the client device to display the set of one or more recommended cost codes to the user;
receiving, from the client device, a second communication comprising an additional set of user-defined information for the time entry that includes a given cost code that has been selected from the one or more recommended cost codes; and
based at least on the initial set of user-defined information and the additional set of user-defined information, creating the new time entry comprising the given cost code.

19. The method of claim 18, wherein the identifying information for the at least one individual working on the construction project includes one or more of: (i) an identifier of the at least one individual or (ii) an identifier of a construction crew with which the at least one individual is associated.

20. The method of claim 18, wherein the context information includes one or more of: (i) schedule information for the construction project, (ii) phase information for the construction project, (iii) budget information for the construction project, (iv) work breakdown structure information for the construction project, (v) location information for the at least one individual, or (vi) previously-entered information for the construction project or the at least one individual.
